(19) United States
(12) Patent Application Publication
(10) Pub. No.: US 2013/0079951 A1
(43) Pub. Date: Mar. 28, 2013

(54) Vehicle Device

(71) Applicant: Boaz M. Brickman, West Orange, NJ (US)

(72) Inventor: Boaz M. Brickman, West Orange, NJ (US)

(73) Assignee: ALCATEL-LUCENT USA INC., Murray Hill, NJ (US)

(21) Appl. No.: 13/240,111

(22) Filed: Sep. 22, 2011

(51) Int. Cl. G05D 1/00

(52) U.S. Cl. 701/2

(57) ABSTRACT

A vehicle actuation device includes a wireless communication device configured to communicate with a remote mobile apparatus via a communication network, an actuator configured to actuate one or more appliances in a vehicle, and a processor configured to resolve a position of the remote mobile apparatus via the wireless communication device. The processor is further configured to control the actuator as a function of parameters. The parameters include a distance threshold of the remote mobile apparatus relative to the vehicle.

The present invention describes actuation devices for vehicles.

### BACKGROUND

This section introduces aspects that may be helpful in facilitating a better understanding of the invention. Accordingly, the statements of this section are to be read in this light and are not to be understood as admissions about what is in the prior art or what is not in the prior art.

There exist remote actuation devices in vehicles today that operate appliances in the vehicle from a command given by a user at a distance from the vehicle.

One such example is a remote car starter, operable from a mobile keychain carried by a user.

An alternative is sought to for the remote actuation of in-vehicle appliances.

### BRIEF SUMMARY

In one aspect, a vehicle actuation device is provided.

In one embodiment, the device includes a wireless communication device configured to communicate with a remote mobile apparatus via a communication network, an actuator configured to actuate one or more appliances in a vehicle, and a processor configured to resolve a position of the remote mobile apparatus via the wireless communication device. The processor is further configured to control the actuator as a function of parameters. The parameters include a distance threshold of the remote mobile apparatus relative to the vehicle.

In another aspect, an actuation system is provided. In one embodiment, the system includes a remote mobile apparatus and a vehicle fitted with a vehicle actuation device. The system further includes a storage device configured for storing the position of the remote mobile apparatus and which the processor is configured to interrogate for resolving the distance threshold of the remote mobile apparatus relative to the vehicle.

In yet another aspect, a method of actuating apparatus in a vehicle is provided. In one embodiment, the method includes requesting position information from a remote mobile apparatus via a communication network on which the remote mobile apparatus operates, and actuating at least one actuator in said vehicle as a function of parameters. The parameters include a distance threshold of the remote mobile apparatus relative to the vehicle.

An advantage of the foregoing is greater flexibility for the system overall to make decisions leveraging increasingly prevalent communication networks in society.

A further advantage is that the system is vehicle-based and vehicle-centric. Operational determinations are made autonomously from the vehicle-side, with communications with the client and data exchange with third-party services and the client all being conducted using existing communication networks. This increases flexibility, lowers cost, and provides for more applications.

### BRIEF DESCRIPTION

Some embodiments of devices and methods in accordance with embodiments of the present invention are now described, by way of example only, and with reference to the accompanying drawings, in which:

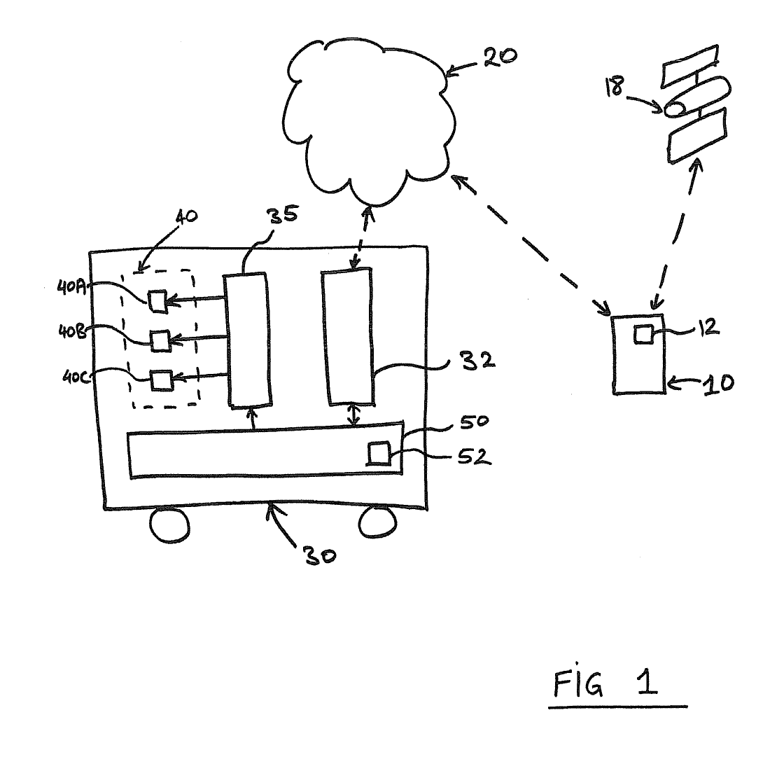

FIG. 1 illustrates schematically an actuation system according to an exemplary embodiment;

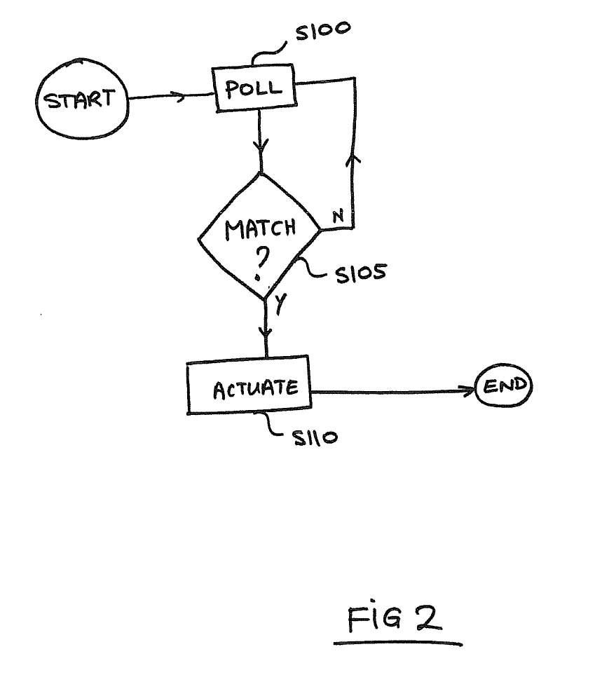

FIG. 2 illustrates a flow diagram of the operation of an exemplary embodiment.

### DETAILED DESCRIPTION

FIG. 1 illustrates an embodiment that includes a mobile apparatus 10, a vehicle system 30, and a communication network 20 with which both the mobile apparatus 10 and the vehicle system 30 may communicate.

The communication network may for example operate according to the following protocols: GSM, CDMA, WCDMA, UMTS, LTE, wifi, internet, Bluetooth, or any other wireless network protocols.

The mobile apparatus 10 includes a localization device 12 configured to determine its position. For example, the localization device 12 may be a GPS receiver configured to communicate with a GPS constellation 18. In another example, the localization device is a subscriber identity module (“SIM”) in a mobile communication network position system, configured for its position to be triangulated from nearby wireless mobile antennas or base stations.

The remote mobile apparatus 10 is typically associated with a user (not shown).

The remote mobile apparatus 10 may for example be a mobile phone, a tactile communication device (for example a Apple® IPad® configured to communicate with the communication network 20), or any other mobile device configured to communicate wirelessly.

The vehicle system 30 may for example be a truck, a van, car, a motorcycle, or other transportation vehicles. The vehicle system 30 comprises an actuator system 35 configured to selectively actuate or enable one or more appliances 40A, 40B, 40C fitted to the vehicle system 30. Appliances 40A, 40B, 40C will be referred to hereafter collectively or individually as “appliance 40” for clarity.

In the context of the present description, an appliance 40 is any electrical or mechanical device installed in the vehicle as factory standard or as an aftermarket option. Examples include: alarm, immobilizer, radio, seat heating, air conditioning, heating, seat positioning, interior lights, sunroof, automatic door opening, and/or engine ignition system.

The vehicle system 30 further comprises a communications module 32 configured to communicate with the communications network 20.

The vehicle system 30 further comprises a processor 50 configured to determine position information of the mobile apparatus 10 via said communications module 32.

The position information may comprise subjective or objective position information. For example, subjective information may indicate that the user was at or passed a particular known location, such as the front door of home, which is able to be resolved to a determined position. This subjective information may for example indicate to the vehicle system 30 that the mobile apparatus 10 passed through the front door of the house.

Objective position information may indicate GPS coordinates obtained from a GPS receiver. For example, the processor 50 can trigger a GPS geolocation operation in the remote mobile apparatus 10 to return its position information.

Objective position information may also be received from the communication network using position determining protocols. For example, the processor 50 triggers network-based positioning systems in the communications network 20 to resolve the location of the remote mobile apparatus 10 by triangulation.

In yet another embodiment, the processor 50 can download or look-up via the communications module 32 position data of the remote mobile apparatus 10 stored in the communication network 20.

The position information is then used by the processor 50 to be able to resolve a relative distance threshold between the mobile apparatus 10 and the vehicle system 30.

The processor 50 further includes a parameters storage unit 52 configured to be factory programmed or user-programmed. The parameters include information linking the processor 50 to one or more determined remote mobile apparatuses 10. This allows for a specific device only to communicate with the vehicle system 30, increasing privacy and security. The parameters further include information related to processor 50 triggering conditions, for example relative position information of the mobile apparatus 10 with respect to the vehicle system 30, temporal information of when the processor 50 operation is enabled or disabled, meteorological information triggering or suppressing operation of the overall system or a particular appliance 50 (for example, when it is raining, the sunroof opening will be disabled but seat heating may be enabled instead), among others.

In an exemplary embodiment, the parameters storage unit 52 may include, for a given mobile apparatus 10, indications of which appliances 40 to actuate when a given set of parameters are united, for example position and time, or position and weather conditions, etc.

The actuator 35 is configured to actuate or enable one or more of the appliances 40 of the vehicle system 30.

In operation, according to a first exemplary embodiment, the processor 50 triggers polling (S100) at regular intervals to determine, for a given remote mobile apparatus 10, information related to the parameters, such as its position, time of day, etc.

According to an exemplary embodiment, the processor 50 polls the remote mobile apparatus 10 for its position. According to another embodiment, the processor triggers a network-based position determination using network-managed triangulation and returns the position of the mobile apparatus.

The information returned from the polling is compared to the parameters required for appliance activation, as stored in the parameters storage unit 52 (S105).

If the information returned from the mobile apparatus 10 matches one or more of the parameters as set in the parameters storage unit 52, then the processor 50 commands the actuator 35 (S110) to actuate one or more of the appliances 40, as a function of the indications contained in the parameters of the parameters storage unit 52. Namely, the appliance 40 associated with the function of the matching parameter is actuated.

If the information returned from the mobile apparatus 10 among others does not match the parameters, then the processor 50 continues polling the remote mobile apparatus 10 (S100).

The system may also include additional characteristics to ensure that any misactuations are avoided. For example, other embodiments may delay activation of appliances 40 while the system checks to see if the mobile apparatus 10 is headed in the direction of the vehicle system 30. For example, if one of the parameters is met, the system further queries the mobile apparatus 10 to ensure that the information on the mobile apparatus 10 remains valid. So, if a user leaves a building with the mobile apparatus 10 and comes within a distance threshold of the vehicle system 30 as set by the parameters that actuate the vehicle system 30, the system will also determine if the mobile apparatus 10 carried by the user is headed in the correct direction of the vehicle system 30. Thus, if one turns away from a vehicle, the vehicle appliances 40 will not be activated. Or, if the appliances 40 are activated, those appliances are deactivated if the parameters are later not met.

The vehicle system 30 may also be configured to have the vehicle actuation device 35 send an audible sound or electronic message to the mobile apparatus 10 indicating that the vehicle actuation system will be activating appliances within the vehicle system 30. Thus, a user can respond to the vehicular system indicating that a given appliance should or should not be activated. In addition, the user will know that appliances in the vehicle have been activated by the system. Thus, any mis-actuations can be corrected.

The vehicle actuation system can also support multiple users based on different wireless mobile apparatuses 10. So, if two people use a single vehicle system 30, the system can distinguish which person is approaching the vehicle based on that person's mobile apparatus 10 and thereby selectively set the appliances 40 based on that user's preferences. Of course, the system could also be configured to determine which mobile apparatus 10 takes priority if two mobile apparatus 10 approach the vehicle at the same or similar times.

A particular use case can be summarized as follows: Given the concept of a connected car, one would like to have the car determine a user's location from the GPS on the user's phone. Once the car knows the location of the user, it can determine whether to remotely start, whether to heat up in the winter or whether to cool down in the summer before the user even reaches the car.

In another use case, the user usually leaves home at 8:30 am. The car accesses the internet a little before 8:30 am to determine the user's location via the user's phone's GPS module. When the user picks up his phone to get ready to move, the GPS location begins to move. The car also knows its location and can therefore determine if the user is moving towards the car. At a certain point, according to programmed parameters, the car will automatically turn on the heat in the winter so when the user arrives at the car, the car is warmed up. In the summer, the car will automatically invoke the air conditioning so the user can enter a cool car. As the user approaches even closer to the car, the car still sensing the user's GPS location via the data network, the car automatically unlocks. The user therefore arrives at the car and can simply open the unlocked doors and step into a temperature-controlled car, without the use of keys.

A person of skill in the art would readily recognize that steps of various above-described methods can be performed by programmed computers. Herein, some embodiments are intended to cover program storage devices, e.g., digital data storage media, which are machine or computer readable and encode machine-executable or computer-executable programs of instructions where said instructions perform some or all of the steps of methods described herein. The program storage devices may be, e.g., digital memories, magnetic storage media such as a magnetic disks or tapes, hard drives, or optically readable digital data storage media. The embodiments are also intended to cover computers programmed to perform said steps of methods described herein.

The present invention may be embodied in other specific apparatus and/or methods. The described embodiments are to be considered in all respects as only illustrative and not restrictive. In particular, the scope of the invention is indicated by the appended claims rather than by the description and figures herein. All changes that come within the meaning and range of equivalency of the claims are to be embraced within their scope.

1. A vehicle actuation device comprising:
a wireless communication device configured to communicate with a remote mobile apparatus via a communication network;
an actuator configured to actuate one or more appliances in a vehicle;
a processor configured to resolve a position of the remote mobile apparatus via said wireless communication device, said processor being further configured to control said actuator as a function of parameters,
wherein said parameters comprise a distance threshold of said remote mobile apparatus relative to said vehicle.

2. A vehicle actuation device according to claim 1, wherein the remote mobile apparatus comprises a mobile telephone.

3. A vehicle actuation device according to claim 2, wherein the wireless communication device is configured to communicate on a wireless telephone network, and wherein the processor is further configured to trigger location-based services on said telephone network to determine the position of said remote mobile apparatus.

4. A vehicle actuation device according to claim 1, wherein the remote mobile apparatus comprises a tactile communication device.

5. A vehicle actuation device according to claim 4, wherein the wireless communication device is configured to communicate on a wireless telephone network, and wherein the processor is further configured to trigger location-based services on said telephone network to determine the position of said remote mobile apparatus.

6. An actuation system comprising a remote mobile apparatus and a vehicle fitted with a vehicle actuation device according to claim 1, said system further comprising a storage device configured for storing the position of said remote mobile apparatus and which the processor is configured to interrogate for resolving the distance threshold of said remote mobile apparatus relative to said vehicle.

7. An actuation system according to claim 6, wherein the processor is configured to trigger via the communication network a position update of the remote mobile apparatus.

8. A method of actuating at least one apparatus in a vehicle, comprising requesting position information from a remote mobile apparatus via a communication network on which the remote mobile apparatus operates; and actuating at least one actuator in said vehicle as a function of parameters, said parameters comprising a distance threshold of said remote mobile apparatus relative to said vehicle.

9. A method according to claim 8, wherein the request for position information comprises a communication message to the remote mobile apparatus via the communication network for the transmission of its position information.
